(19) United States
(12) Patent Application Publication
(10) Pub. No.: US 2026/0109032 A1
(43) Pub. Date: Apr. 23, 2026

(54) TRANSFER ROBOT

(71) Applicant: KABUSHIKI KAISHA YASKAWA DENKI, Kitakyushu-shi (JP)

(72) Inventors: Ikuro HIRATA, Kitakyushu-shi (JP); Akihiro TASHIRO, Kitakyushu-shi (JP); Chengbi ZHAO, Kitakyushu-shi (JP); Kengo FUNADA, Kitakyushu-shi (JP)

(73) Assignee: KABUSHIKI KAISHA YASKAWA DENKI, Kitakyushu-shi (JP)

(21) Appl. No.: 19/318,370

(22) Filed: Sep. 4, 2025

(30) Foreign Application Priority Data
Oct. 18, 2024 (JP) 2024-184226

(51) Int. Cl. B25J 9/16; B25J 9/00; B25J 9/04; B25J 9/10; B25J 19/00

(52) U.S. Cl. CPC B25J 9/1651; B25J 9/0009; B25J 9/042; B25J 9/104; B25J 19/0025

(57) ABSTRACT

A transfer robot includes a base; an arm having a first arm rotatable about a first axis; a workpiece holder connected to a distal end of the arm and configured to hold a workpiece; a motor provided inside the first arm such that a motor axis is offset from the first axis by a first predetermined distance; a speed reducer provided between the base and the first arm and including an input shaft and an output shaft that is connected to the base and configured to be rotated by the input shaft with a reduced rotation speed; a transmission provided inside the first arm and configured to transmit rotational power of the motor to the input shaft; and a motor support provided inside the first arm to support the motor such that the motor is separated from a housing of the first arm.

### CROSS-REFERENCE TO RELATED APPLICATIONS

The present application claims priority under 35 U.S.C. § 119 to Japanese Patent Application No. 2024-184226, filed Oct. 18, 2024. The contents of this application are incorporated herein by reference in their entirety.

### BACKGROUND

### Technical Field

The present disclosure relates to a transfer robot.

### Discussion of the Background

Conventionally, a horizontal articulated robot is known as one of the transfer robots for transferring a workpiece such as a glass substrate or a semiconductor wafer to a desired position. For example, a transfer robot described in Japanese Patent Application Publication No. 2012-186389 includes a swing arm, an arm unit, and a base portion.

### SUMMARY

In accordance with one aspect of the present disclosure, a transfer robot includes a base; an arm having a distal end and including a first arm rotatable about a first axis that extends along a height direction of the transfer robot; a workpiece holder connected to the distal end of the arm and configured to hold a workpiece; a motor having a motor shaft rotatable around a motor axis and provided inside the first arm such that the motor axis is offset from the first axis by a first predetermined distance; a speed reducer provided between the base and the first arm such that the first axis passes through the speed reducer and including an input shaft configured to be rotated around a rotation axis by the motor; a transmission provided inside the first arm and configured to transmit rotational power of the motor to the input shaft; and a motor support provided inside the first arm to support the motor such that the motor is separated from a housing of the first arm. The speed reducer includes an output shaft connected to the base and configured to be rotated by the input shaft with a reduced rotation speed.

In accordance with another aspect of the present disclosure, a transfer robot includes a base; an arm having a distal end and including a first arm rotatable about a first axis that extends along a height direction of the transfer robot; a workpiece holder connected to the distal end of the arm and configured to hold a workpiece; a motor having a motor shaft rotatable around a motor axis and provided inside the first arm such that the motor axis is offset from the first axis by a first predetermined distance; a speed reducer provided between the base and the first arm and including an input shaft configured to be rotated around a rotation axis by the motor and provided such that the rotation axis of the input shaft is offset from the first axis by a second predetermined length; and a transmission provided inside the first arm and configured to transmit rotational power of the motor to the input shaft. The speed reducer includes an output shaft provided coaxially with the first axis and configured to be rotated by the input shaft with a reduced rotation speed. The speed reducer has a hollow passing through the speed reducer along the first axis.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a perspective view showing an example of an external configuration of a transfer robot common to a first embodiment and a second embodiment.

FIG. 2 is a perspective view showing an example of an external configuration of a transfer robot common to the first embodiment and the second embodiment.

FIG. 3 is a cross-sectional perspective view illustrating an example of an internal configuration of a first arm of the transfer robot according to the first embodiment, as viewed from an upper oblique side in a height direction.

FIG. 4 is a side sectional view showing an example of an internal configuration of a first arm of the transfer robot according to the first embodiment, as viewed from a width direction.

FIG. 5 is a cross-sectional perspective view illustrating an example of a cable arrangement inside the first arm of the transfer robot according to the first embodiment, as viewed from an upper oblique side in the height direction.

FIG. 6 is a side sectional view showing an example of a cable arrangement inside the first arm of the transfer robot according to the first embodiment, as viewed from the width direction.

FIG. 7 is a side sectional view conceptually illustrating an example of an internal configuration of a first arm according to a modification example of the first embodiment, as viewed from the width direction.

FIG. 8 is a side cross-sectional view conceptually illustrating another example of the internal configuration of the first arm according to the modification example of the first embodiment, as viewed from the width direction.

FIG. 9 is a cross-sectional perspective view illustrating an example of an internal configuration of a first arm of the transfer robot according to the second embodiment, as viewed from an upper oblique side in a height direction.

FIG. 10 is a side sectional view showing an example of an internal configuration of a first arm of the transfer robot according to the second embodiment, as viewed from the width direction.

FIG. 11 is a cross-sectional perspective view illustrating an example of a cable arrangement inside a first arm of the transfer robot according to the second embodiment, as viewed from an upper oblique side in a height direction.

FIG. 12 is a side sectional view showing an example of the arrangement of cables inside the first arm of the transfer robot according to the second embodiment, as viewed from the width direction.

### DESCRIPTION OF THE INVENTION

Hereinafter, embodiments will be described with reference to the drawings.

### <External Configuration of Transfer Robot>

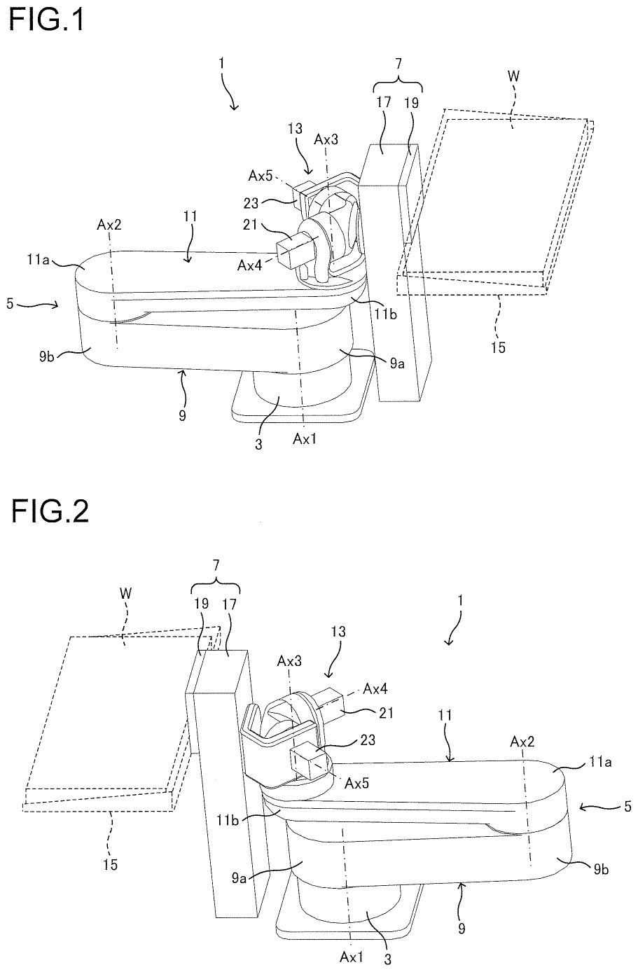

An example of an external configuration of a transfer robot common to the first embodiment and the second embodiment will be described with reference to FIGS. 1 and 2.

The transfer robot 1 shown in FIGS. 1 and 2 performs an operation of receiving a workpiece W and transporting the workpiece W to a target position. A controller (not illustrated) is connected to the transfer robot 1, and the controller controls the operation of the transfer robot 1.

The type of the workpiece W to be conveyed by the transfer robot 1 is not particularly limited. The workpiece W may be a heavy object. The weight of the workpiece W may be, for example, equal to or greater than 300 kg, equal to or greater than 450 kg, or equal to or greater than 600 kg. That is, the load capacity of the transfer robot 1 may be equal to or greater than 300 kg, equal to or greater than 450 kg, or equal to or greater than 600 kg. The workpiece W may be, for example, a battery module for driving an electric vehicle. In this case, the workpiece W may be a single battery module or a plurality of battery modules that are collectively transported. The workpiece W may be a battery unit in which a plurality of battery modules are integrated. The transfer robot 1 may transport the workpiece W with a shelf on which a plurality of cells are vertically arranged as a target position. In addition, when the workpiece W is attached to another workpiece, the workpiece W may be conveyed with the attachment position as the target position.

As shown in FIGS. 1 and 2, the transfer robot 1 includes a base 3, an arm 5, and a workpiece holder 7. The arm 5 is a horizontal articulated robot arm. The arm 5 includes a first arm 9, a second arm 11, and a posture adjuster 13.

The base 3 is a base member fixed to, for example, a horizontal floor surface or a horizontal stand. The base 3 supports other members such as the arm 5 included in the transfer robot 1. The base 3 is fixed to a floor surface or the like, and thus the transfer robot 1 is fixed in a region where work is performed on the workpiece W. The floor or the stand may be inclined with respect to the horizontal. The base 3 may be fixed to, for example, a wall surface or a ceiling.

The first arm 9 is connected to the base 3 so as to be rotatable about a first axis Ax1 along the height direction of the transfer robot 1. The first arm 9 rotates about the first axis Ax1 with respect to the base 3. In the embodiment, the proximal end portion 9a of the first arm 9 is rotatably connected to the upper portion of the base 3. The first arm 9 extends horizontally in a direction away from the first axis Ax1. The height direction of the transfer robot 1 is a vertical direction perpendicular to the horizontal direction when the base 3 is fixed to a horizontal floor surface or the like as in the present embodiment. That is, the height direction of the transfer robot 1 is a direction perpendicular to the installation surface of the base 3. For example, when the base 3 is fixed to a floor surface or the like inclined with respect to the horizontal direction, the height direction of the transfer robot 1 is a direction perpendicular to the inclination direction, and when the base 3 is fixed to a vertical wall surface or the like, the height direction of the transfer robot 1 is a horizontal direction perpendicular to the vertical direction.

The second arm 11 is connected to the first arm 9 to be rotatable about a second axis Ax1 parallel to the first axis Ax2. The second arm 11 rotates about the second axis Ax2 with respect to the first arm 9. In the embodiment, the base end portion 11a of the second arm 11 is rotatably connected to the upper portion of the distal end portion 9b of the first arm 9. The second arm 11 extends horizontally in a direction away from the second axis Ax2.

The workpiece holder 7 is connected to the distal end of the arm 5 and is configured to hold the workpiece W via the holding member 15. The holding member 15 is, for example, a flat plate-shaped member, and holds the workpiece W mounted thereon. The workpiece holder 7 is connected to the second arm 11 via the posture adjuster 13 so as to rotate about a third axis Ax2 parallel to the second axis Ax3. The workpiece holder 7 rotates about the third axis Ax3 with respect to the second arm 11. In the embodiment, the workpiece holder 7 is connected to an upper portion of the 11b of the distal end portion of the second arm 11 via the posture adjuster 13.

The workpiece holder 7 includes a lifting base portion 17 and a movable portion 19. The lifting base portion 17 is supported by the posture adjuster 13. The lifting base portion 17 is configured to extend in a direction intersecting the extending direction of the second arm 11. The extending direction of the second arm 11 is a direction in which a line segment connecting the second axis Ax2 and the third axis Ax3 in the shortest length extends. The posture of the workpiece holder 7 is changed by the posture adjuster 13. Therefore, the direction in which the lifting base portion 17 extends may substantially coincide with the vertical direction or may be inclined with respect to the vertical direction.

The movable portion 19 supports the holding member 15. In the embodiment, the holding member 15 is supported so that the holding member 15 is disposed on the side of the workpiece holder 7. The movable portion 19 is provided on the lifting base portion 17 so as to move along the direction in which the lifting base portion 17 extends. The movable portion 19 moves along the extending direction of the lifting base portion 17.

The posture adjuster 13 adjusts the posture of the workpiece W held by the workpiece holder 7. The posture of the workpiece holder 7 is adjusted by the posture adjuster 13, and thus the posture of the workpiece W held by the holding member 15 is adjusted. The posture adjuster 13 is provided between the second arm 11 and the workpiece holder 7. In the embodiment, the posture adjuster 13 is provided to be rotatable about the third axis 11b with respect to the distal end portion Ax3 of the second arm 11.

The posture adjuster 13 includes a first adjuster 21 and a second adjuster 23. The first adjuster 21 is an adjuster that rotates the workpiece holder 7 around the fourth axis Ax4. The second adjuster 23 is an adjuster that rotates the workpiece holder 7 about the fifth axis Ax5. Each of the first adjuster 21 and the second adjuster 23 includes, for example, a motor, a speed reducer 29, and the like. The posture adjuster 13 changes the posture of the workpiece holder 7 by the first adjuster 21 and the second adjuster 23.

The fourth axis Ax4 and the fifth axis Ax5 are set to intersect each other. The fourth axis Ax4 and the fifth axis Ax5 are axes included in the same plane intersecting the third axis Ax3, and intersect each other so as to have an intersection point. The fourth axis Ax4 and the fifth axis Ax5 may be set to have an intersection on the third axis Ax3, or may be set to have an intersection at a position away from the third axis Ax3, for example.

The configuration of the transfer robot 1 described above is an example, and the present invention is not limited to the above description. For example, the arm 5 may include three or more arms. Further, the posture adjuster 13 may not be provided, and the workpiece holder 7 may be coupled to the distal end 11b of the second arm 11 to be rotatable about the third axis Ax3 without the posture adjuster 13. Further, the posture adjuster 13 may be provided with a balancer member for generating a correction force against the weight of the workpiece W.

### 2. First Embodiment

First, a first embodiment will be described. The first embodiment is an embodiment in which a motor that rotates the first arm 9 about the first axis Ax1 with respect to the base 3 is supported so as to be spaced apart from the housing 25 of the first arm 9.

### (2-1. Internal Configuration of First Arm of Transfer Robot 1)

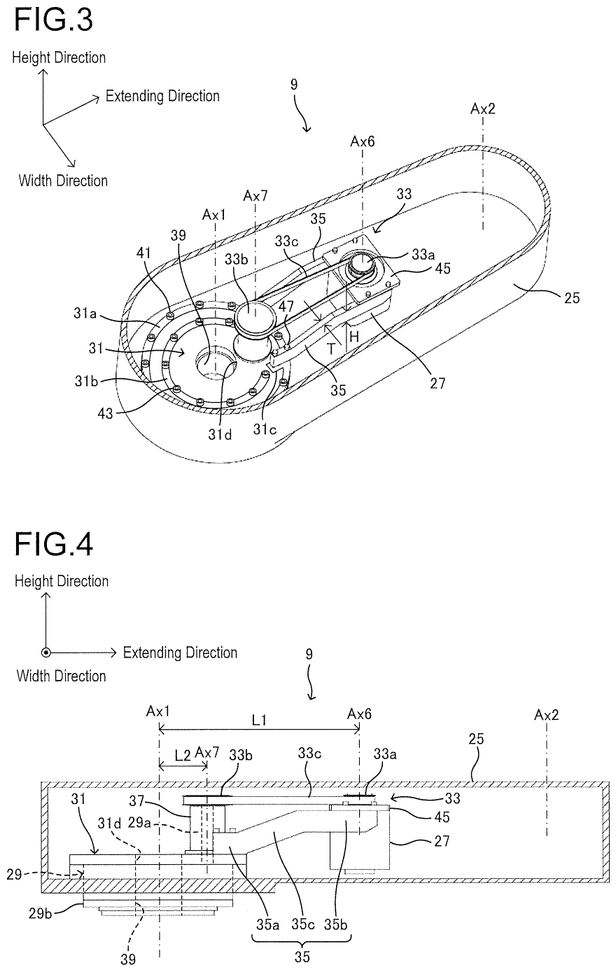

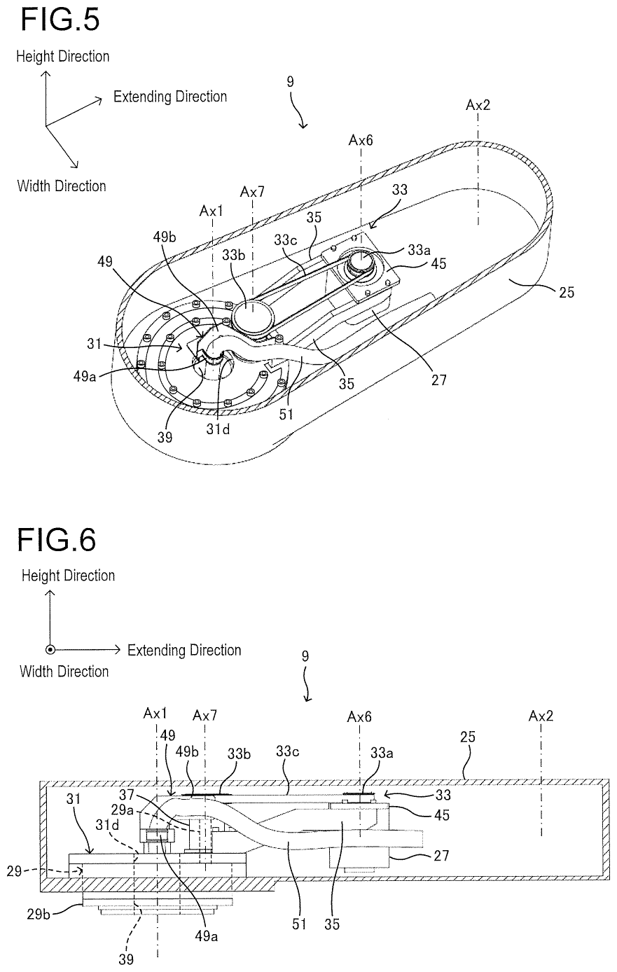

An example of an internal configuration of the first arm of the transfer robot 1 according to the first embodiment will be described with reference to FIGS. 3 to 6. FIG. 3 is a cross-sectional perspective view illustrating an example of an internal configuration of a first arm of the transfer robot 1 according to the first embodiment when viewed from an upper oblique side in a height direction, FIG. 4 is a cross-sectional side view illustrating an example of a cable arrangement inside the first arm of the transfer robot 1 according to the first embodiment when viewed from a width direction, and FIG. 6 is a cross-sectional side view illustrating an example of a cable arrangement inside the first arm of the transfer robot 1 according to the first embodiment when viewed from a width direction. In FIGS. 3 and 4, the cable, the cable support member, and the like shown in FIGS. 5 and 6 are not shown.

As illustrated in FIGS. 3 and 4, the first arm 9 includes a housing 25 having a hollow structure extending in the extending direction of the first arm 9. The extending direction of the first arm 9 is a direction in which a line segment connecting the first axis Ax1 and the second axis Ax2 in the shortest length extends. The first arm 9 includes, inside the housing 25, the motor 27, a part of the speed reducer 29, a flange (an example of a “connector”) 31, the transmission 33, and the motor support 35.

The motor 27 is a power source for rotating the first arm 9 about the first axis Ax1 with respect to the base 3. The motor 27 rotates a drive shaft (not illustrated) about the sixth axis Ax6. As shown in FIG. 4, the motor 27 is disposed such that the sixth axis Ax6 is offset from the first axis Ax1 by a length L1 (an example of a first predetermined length) in the extending direction of the first arm 9. The motor 27 may be disposed such that the sixth axis Ax6 is offset by the length L1 in a direction (for example, an oblique direction offset in the extending direction and the widthwise direction, the opposite side to the second axis Ax2, the widthwise direction, or the like) deviated from the extending direction of the first arm 9.

As shown in FIG. 4, the speed reducer 29 is disposed on the first axis Ax1 between the base 3 and the first arm 9. The speed reducer 29 includes an input shaft 29a that inputs the rotation of the motor 27, and an output shaft 29b that reduces the rotation speed of the input shaft 29b and outputs the rotation. The input shaft 29a is supported by a bearing member 37 provided on an upper portion of the flange 31 to be rotatable about the seventh axis Ax7. The input shaft 29a is disposed such that the seventh axis Ax7 is offset from the first axis Ax1 toward the motor 27 by a length L2 (an example of a second predetermined length) along the extending direction of the first arm 9. The input shaft 29a may be disposed so that the seventh axis Ax7 is offset from the first axis Ax1 by the length L2 in a direction (for example, an oblique direction offset in the extending direction and the widthwise direction, the opposite side to the motor 27, the widthwise direction, or the like) deviated from the extending direction of the first arm 9. As shown in FIGS. 3 and 4, the speed reducer 29 has a hollow portion 39 penetrating along the first axis Ax1. The length L2 is set so that the bearing member 37 does not interfere with the hollow portion 39 (the opening 31d of the flange 31) of the speed reducer 29. As illustrated in FIG. 4, at least a part of the output shaft 29b is disposed outside the housing 25 of the first arm 9, and is fixed to the base 3. The output shaft 29b is disposed coaxially with the first axis Ax1. A hollow portion 39 is formed in the output shaft 29b.

The flange 31 (an example of the connector) connects the speed reducer 29 to the housing 25 of the first arm 9. As shown in FIGS. 3 and 4, the flange 31 is a disk-shaped member having an opening 31d formed at the center thereof and communicating with the hollow portion 39 of the speed reducer 29. As shown in FIG. 3, the flange 31 has a first fixing portion 31a having, for example, an annular shape and a second fixing portion 31b having, for example, an annular shape. A plurality of first bolts 41 for fixing the flange 31 to the housing 25 are inserted through the first fixing portion 31a and fastened to the housing 25. The second fixing portion 31b is disposed on the inner peripheral side of the first fixing portion 31a, and a plurality of second bolts 43 for fixing the speed reducer 29 to the flange 31 are inserted through the second fixing portion 31b and fastened to the speed reducer 29. At least one of the first fixing portion 31a and the second fixing portion 31b may be formed in a shape other than the annular shape, for example, an arc shape in which the annular shape is broken in the middle, a linear shape, a quadrangular shape, or the like. The first fixing portion 31a, the second fixing portion 31b, the first bolt 41, the second bolt 43, and the like are not illustrated in FIGS. 4 and 6. Note that the flange 31 may be integrally formed with the housing 25 of the first arm 9.

The transmission 33 transmits the power of the motor 27 to input shaft 29a of the speed reducer 29. As shown in FIGS. 3 and 4, the transmission 33 includes a first pulley 33a coupled to the output shaft of the motor 27, a second pulley 33b coupled to the input shaft 29a of the speed reducer 29, and a belt 33c wound around the first pulley 33a and the second pulley 33b. The first pulley 33a and the second pulley 33b are disposed at substantially the same height position in the height direction of the transfer robot 1.

The motor support 35 supports the motor 27 in a state of being separated from the housing 25 of the first arm 9. As shown in FIGS. 3 and 4, the motor support 35 has a structure in which one end is fixed to the flange 31 and the motor 27 is fixed to the other end, so that the one end is supported in a cantilever manner by the housing 25. As shown in FIG. 3, the pair of motor supports 35 are disposed so as to face each other in the width direction of the first arm 9 perpendicular to the extending direction of the first arm 9 and the height direction of the transfer robot 1, and support the motor 27 so as to sandwich the motor 27 at the other end. The motor support 35 may not be two (a pair), may be one, and may be formed in a plate shape. The motor support 35 may be formed integrally with the flange 31 or the housing 25.

As shown in FIG. 4, each motor support 35 has a first horizontal portion 35a, a second horizontal portion 35b, and an inclined portion 35c. The first horizontal portion 35a extends horizontally in a direction perpendicular to the height direction of the transfer robot 1 and is fixed to the flange 31. The second horizontal portion 35b extends horizontally, and the motor 27 is fixed to the second horizontal portion 35b via a motor flange 45 having a substantially rectangular plate shape. The inclined portion 35c extends in a direction inclined with respect to the lateral direction and connects the first horizontal portion 35a and the second horizontal portion 35b. The first horizontal portion 35a, the second horizontal portion 35b, and the inclined portion 35c may extend along the extending direction of the first arm 9, or may extend along a direction deviated from the extending direction (for example, an oblique direction offset in the extending direction and the widthwise direction, the opposite side to the second axis Ax2, the widthwise direction, or the like).

As shown in FIG. 3, each motor support 35 has a height H, which is a dimension in the height direction of the transfer robot 1, larger than a thickness T, which is a dimension in the width direction of the first arm 9. The height H and the thickness T are common to the first horizontal portion 35a, the second horizontal portion 35b, and the inclined portion 35c of the motor support 35. At least one of the height H and the thickness T may be different in each of the first horizontal portion 35a, the second horizontal portion 35b, and the inclined portion 35c of the motor support 35.

As shown in FIG. 3, the flange 31 has a third fixing portion 31c extending from the first fixing portion 31a toward the inner peripheral side. The third fixing portion 31c is provided at two positions corresponding to each of the pair of motor supports 35, and extends by a length corresponding to the first horizontal portion 35a along the extending direction of the first horizontal portion 35a of the motor support 35. A plurality of third bolts 47 for fixing the motor support 35 to the flange 31 are fastened to the third fixing portion 31c through the first horizontal portion 35a. The third fixing portion 31c may extend from the first fixing portion 31a toward the outer peripheral side, or may be provided at the same position as the first fixing portion 31a. When the motor support 35 is integrally formed with the flange 31 or the housing 25, the third fixing portion 31c is not necessary.

As shown in FIGS. 5 and 6, a cable support member 49 is provided on the upper portion of the flange 31 at a position different from the input shaft 29a of the speed reducer 29 in the vicinity of the hollow portion 39 (opening 31d of the flange 31) of the speed reducer 29. The cable support member 49 (an example of the wire body support) has a support portion 49a and a guide portion 49b. The support portion 49a supports the cable 51 (an example of a wire body) passing through the hollow portion 39 of the speed reducer 29 at a position between the transmission 33 and the flange 31 in the direction of the first axis Ax1, that is, in the height direction of the transfer robot 1. The guide portion 49b guides the cable 51 held by the support portion 49a so as to be disposed on one side in the widthwise direction of the first arm 9 with respect to the bearing member 37, the pair of motor supports 35, and the like at a height position between the transmission 33 and the flange 31. Accordingly, the cable 51 is wired so as to avoid (detour) the input shaft 29a of the speed reducer 29, the transmission 33, the pair of motor supports 35, the motor 27, and the like in the widthwise direction of the first arm 9. The type of the cable 51 is not particularly limited, and may include a power supply line, a control line, and the like. The cable support member 49 may support, for example, a tube or the like (an example of a line) through which a fluid such as air or paint flows, instead of or in addition to the cable 51.

### 2-2. Effects of First Embodiment

As described above, in the transfer robot 1 of the first embodiment, the motor support 35 supports the motor 27 in a state of being separated from the housing 25 of the first arm 9.

Accordingly, even when deformation such as deflection occurs in the housing 25 of the first arm 9 due to the workpiece holder 7 holding the heavy workpiece W, the position and the direction of the motor 27 are less likely to be affected by the deformation of the housing 25. As a result, it is possible to suppress the occurrence of deformation in the transmission 33 that transmits the power of the motor 27 to the input shaft 29a of the speed reducer 29, and thus it is possible to suppress the deformation of the transmission 33 without improving the rigidity of the housing 25. This can suppress a decrease in the power transmission function of the transmission 33, a reduction in the life of the transmission 33, and the like. Therefore, even when a heavy object is conveyed, it is possible to suppress deformation of the transmission 33 while suppressing an increase in the size of the transfer robot 1.

In the present embodiment, the motor support 35 may be a cantilever member in which the one end is fixed to the flange 31, the motor 27 is fixed to the other end, and the one end is supported by the housing 25. In this case, the one end of the motor support 35 can be fixed to the vicinity of the input shaft 29a of the speed reducer 29 to which the power of the motor 27 is transmitted, and thus it is possible to reduce the influence of the deformation of the housing 25 of the first arm 9 on the power transmission function and the life of the transmission 33.

In the present embodiment, the flange 31 may include a first fixing portion 31a, a second fixing portion 31b, and a third fixing portion 31c. In this case, the motor support 35 can be firmly fixed to the flange 31 by fastening the plurality of third bolts 47 to the third fixing portion 31c.

In the present embodiment, the height H, which is the dimension of the motor support 35 in the height direction, may be larger than the thickness T, which is the dimension of the motor support 35 in the width direction. In this case, the rigidity of the motor support 35 against bending in the height direction can be increased (the natural frequencies of the housing 25 and the motor support 35 with respect to the vibration mode in which the housing 25 and the motor support 35 bend in the height direction can be made different from each other). Therefore, resonance with vibration caused by deformation of the housing 25 of the first arm 9 can be suppressed, and thus the support of the motor 27 can be stabilized. Further, since deformation of the motor support 35 due to the weight of the motor 27 and the like supported thereby can be suppressed, positional deviation of the motor 27 or the first pulley 33a can be suppressed.

In the present embodiment, a pair of motor supports 35 may be disposed so as to face each other in the width direction of the first arm 9, and the motor 27 may be supported so as to be sandwiched by the other end of the pair of motor supports 35. In this case, the rigidity of the motor support 35 against the rotation operation of the first arm 9 can be enhanced. Therefore, the motor support 35 is less likely to be deformed in the rotation direction of the first arm 9, and thus the support of the motor 27 can be stabilized.

In the present embodiment, the motor support 35 may include a first horizontal portion 35a, a second horizontal portion 35b, and an inclined portion 35c. In this case, the layout of the motor 27, the input shaft 35c of the speed reducer 29, and the like can be adjusted by adjusting the angle and length of the inclined portion 35c. Therefore, the height dimension of the first arm 9 can be reduced, and the transfer robot 1 can be downsized.

In the present embodiment, the speed reducer 29 may have a hollow portion 39 penetrating along the first axis Ax1. In this case, the cable 51 and the like can be wired in the first arm 9 by penetrating the speed reducer 29.

In the present embodiment, the speed reducer 29 may be configured such that the output shaft 29b is disposed coaxially with the first axis Ax1 and the input shaft 29a is offset from the first axis Ax1 toward the motor 27 by the length L2. In this case, the input shaft 29a (the bearing member 37) can be prevented from interfering with the cable 51 and the like passing through the hollow portion 39 of the speed reducer 29.

In the present embodiment, a cable support member 49 may be provided to support the cable 51 and the like passing through the hollow portion 39 of the speed reducer 29 at a position between the transmission 33 and the flange 31 in the direction of the first axis Ax1. In this case, the cable 51 and the like passing through the hollow portion 39 can be wired at a height between the transmission 33 and the flange 31 in the first arm 9. This makes it possible to reduce the height dimension of the first arm 9, and to reduce the size of the transfer robot 1.

In the present embodiment, the transmission 33 may include a first pulley 33a, a second pulley 33b, and a belt 33c. In this case, it is possible to suppress the occurrence of variation in the axial length or axial direction of the two pulleys 33a and 33b (the axial length or axial direction of the output shaft of the motor 27 and the input shaft 29a of the speed reducer 29), and thus it is possible to suppress variation in the belt tensile force without increasing the rigidity of the housing 25. Accordingly, the belt tension can be maintained within an appropriate range, and thus it is possible to suppress a decrease in power transmission function, damage to the belt, a decrease in life, and the like due to the belt tension being out of the allowable range. Therefore, even when a heavy object is conveyed, it is possible to suppress the variation in the belt tension in the transmission 33 while suppressing the increase in the size of the transfer robot 1.

### 2-3. Modification of First Embodiment

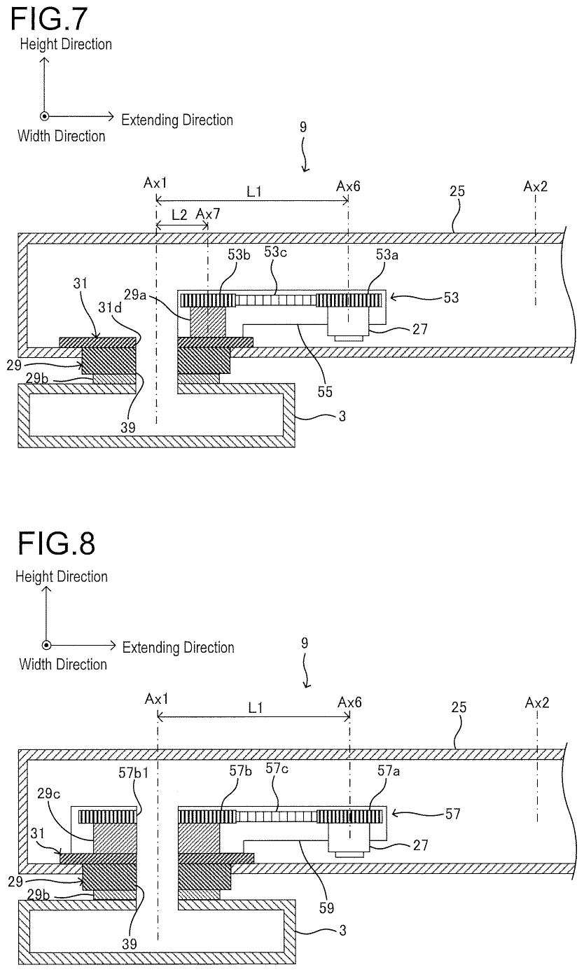

The first embodiment is not limited to the above, and various modifications can be made without departing from the spirit and technical idea of the first embodiment. For example, in the first embodiment, the transmission 33 is configured by the pulley and the belt, but the transmission 33 may be configured by a gear train including a plurality of gears. An example of an internal configuration of a first arm of a transfer robot according to the present modification will be described with reference to FIGS. 7 and 8. FIG. 7 is a side sectional view conceptually illustrating an example of an internal configuration of a first arm according to a modification example of the first embodiment when viewed from the width direction, and FIG. 8 is a side sectional view conceptually illustrating another example of the internal configuration of the first arm according to the modification example of the first embodiment when viewed from the width direction. In FIGS. 7 and 8, the same components as those in FIG. 4 and the like described above are denoted by the same reference numerals, and description thereof will be omitted as appropriate. In FIGS. 7 and 8, the cable, the cable support member, and the like are not illustrated.

FIG. 7 shows a configuration example in which the input shaft 29a of the speed reducer 29 is disposed to be offset from the output shaft 29b, as in the first embodiment. As illustrated in FIG. 7, the first arm 9 includes the motor 27, a part of the speed reducer 29, the flange 31, a transmission 53, and a gear train box 55 inside the housing 25.

The transmission 53 transmits the power of the motor 27 to input shaft 29a of the speed reducer 29. As shown in FIG. 7, the transmission 53 includes a first gear 53a coupled to the output shaft of the motor 27, a second gear 53b coupled to the input shaft 29a of the speed reducer 29, and a relay gear 53a that meshes with the first gear 53b and the second gear 53c. The first gear 53a, the second gear 53b, and the relay gear 53c are housed in the gear train box 55 and rotatably supported. The first gear 53a, the second gear 53b, and the relay gear 53c are disposed at substantially the same height position in the height direction of the transfer robot 1, and are disposed in a line along the extending direction of the first arm 9. The relay gear may be configured by two or more gears, or the first gear and the second gear may be configured to mesh with each other without providing the relay gear. At least one of the first gear 53a and the relay gear 53c may be disposed in a direction deviated from the extending direction of the first arm 9 with respect to the second gear 53b.

The gear train box 55 (an example of the motor support 35) supports the motor 27 in a state of being separated from the housing 25 of the first arm 9. As shown in FIG. 7, the gear train box 55 has a structure in which one end is fixed to the flange 31 and the motor 27 is fixed to the other end, so that the one end is supported in a cantilever manner by the housing 25. The configuration other than the above is the same as that of the first embodiment, and thus the description thereof will be omitted.

FIG. 8 shows a configuration example in which the input shaft 29a and the output shaft 29b of the speed reducer 29 are coaxially arranged. As illustrated in FIG. 8, the first arm 9 includes the motor 27, a part of the speed reducer 29, the flange 31, a transmission 57, and a gear train box 59 inside the housing 25.

The speed reducer 29 includes an input shaft 29c that inputs the rotation of the motor 27, and an output shaft 29c that reduces the rotation speed of the input shaft 29b and outputs the rotation. The input shaft 29c and the output shaft 29b are supported to be rotatable about the first axis Ax1. A hollow portion 39 is provided in the input shaft 29c and the output shaft 29b.

The transmission 57 transmits the power of the motor 27 to the input shaft 29c of the speed reducer 29. As shown in FIG. 8, the transmission 57 includes a first gear 57a coupled to the outputting shaft of the motor 27, a second gear 57b coupled to the inputting shaft 57b of the speed reducer 29, and a relay gear 57a meshing with the first gear 57b and the second gear 57c. The first gear 57a, the second gear 57b, and the relay gear 57c are housed in the gear train box 59 and rotatably supported. An opening 57b communicating with the hollow portion 39 of the speed reducer 29 is formed at the center of the second gear 57b1. The first gear 57a, the second gear 57b, and the relay gear 57c are disposed at substantially the same height position in the height direction of the transfer robot 1, and are disposed in a line along the extending direction of the first arm 9. The relay gear may be configured by two or more gears, or the first gear and the second gear may be configured to mesh with each other without providing the relay gear. At least one of the first gear 57a and the relay gear 57c may be disposed in a direction deviated from the extending direction of the first arm 9 with respect to the second gear 57b.

The gear train box 59 (an example of the motor support 35) supports the motor 27 in a state of being separated from the housing 25 of the first arm 9. As shown in FIG. 8, the gear train box 59 has a structure in which one end is fixed to the flange 31 and the motor 27 is fixed to the other end, so that the one end is supported in a cantilever manner by the housing 25. The configuration other than the above is the same as that of the first embodiment, and thus the description thereof will be omitted.

In a case where the transmission 53, 57 is formed of a gear train as in the present modification, when the transmission 53, 57 is deformed, the power transmission function of the gear and the life of the gear may be affected. Specifically, when a variation occurs in the distance between the axes of the gears constituting the transmission 53, 57 or in the axial direction (relative posture between the axes), the backlash may vary. For example, when the distance between the shafts is increased, the backlash is increased, and the meshing is shallow, so that the power may not be transmitted well. On the other hand, if the distance between the shafts is reduced, the backlash is reduced, and there is a possibility that the gear is damaged or the gear does not rotate if the backlash is too small. On the other hand, if the rigidity of the housing 25 is improved in order to suppress the deflection of the housing 25, the size of the drive components such as the motor and the speed reducer 29 may be increased with an increase in the weight of the transfer robot 1.

According to the present modification, the gear train box 55, 59 supports the motor 27 in a state of being separated from the housing 25 of the first arm 9. Accordingly, it is possible to suppress the occurrence of a variation in the inter-axial distance or the axial direction of each gear constituting the transmission 53, 57, and thus it is possible to suppress the variation in the inter-axial distance or the axial direction without improving the rigidity of the housing 25. Accordingly, the inter-shaft distance can be maintained within an appropriate range, and thus it is possible to suppress a decrease in power transmission function, damage to the gear, a decrease in life, and the like due to the inter-shaft distance being out of the allowable range. Therefore, even when a heavy object is conveyed, deformation of the transmission 53, 57 can be suppressed while suppressing an increase in the size of the transfer robot 1.

### 3. Second Embodiment

Next, a second embodiment will be described. The second embodiment is an embodiment in which a motor that rotates the first arm 9 about the first axis Ax1 with respect to the base 3 is installed in a housing of the first arm 9.

(3-1. Internal Configuration of First Arm of Transfer robot)

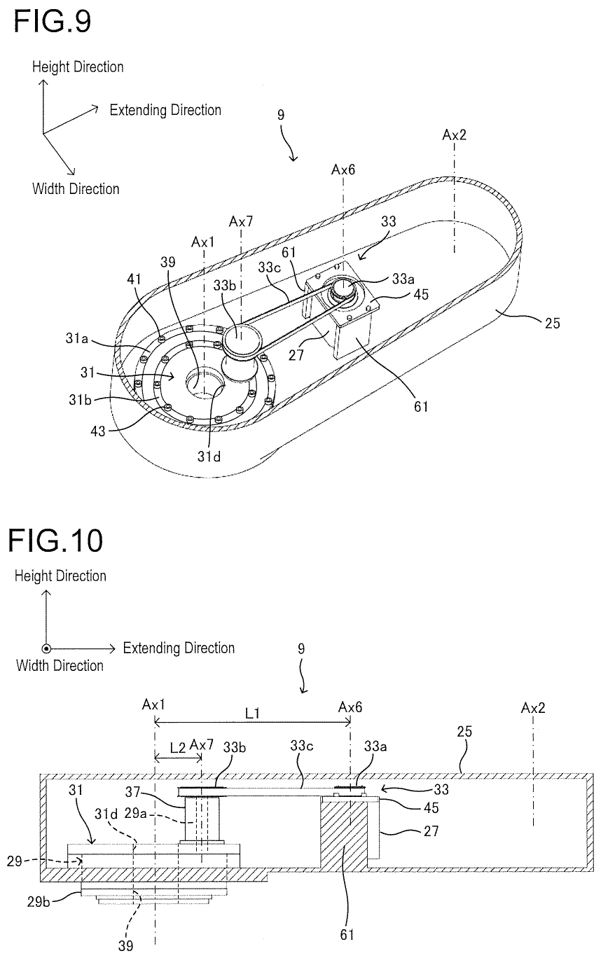

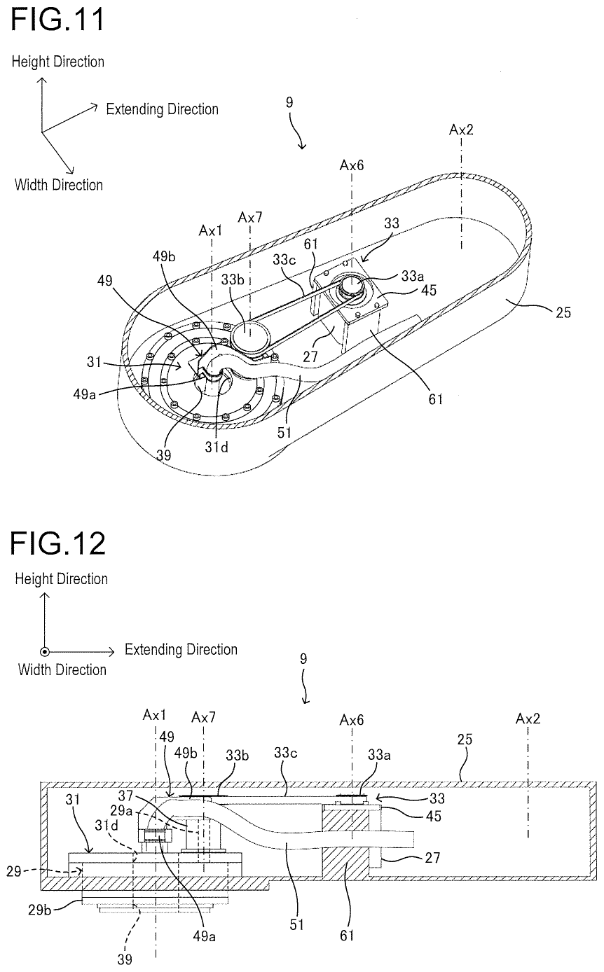

An example of the internal configuration of the first arm of the transfer robot 1 according to the second embodiment will be described with reference to FIGS. 9 to 12. FIG. 9 is a cross-sectional perspective view illustrating an example of an internal configuration of a first arm of a transfer robot 1 according to a second embodiment, as viewed obliquely from above in a height direction, FIG. 10 is a cross-sectional perspective view illustrating an example of a cable arrangement inside the first arm of the transfer robot 1 according to the second embodiment, as viewed obliquely from above in a height direction, and FIG. 12 is a cross-sectional side view illustrating an example of a cable arrangement inside the first arm of the transfer robot 1 according to the second embodiment, as viewed from above in a width direction. In FIGS. 9 and 10, the cable, the cable support member, and the like illustrated in FIGS. 11 and 12 are not illustrated. In FIGS. 9 to 12, the same components as those in FIGS. 3 to 6 described above are denoted by the same reference numerals, and description thereof will be omitted as appropriate.

As illustrated in FIGS. 9 and 10, the first arm 9 includes the motor 27, a part of the speed reducer 29, the flange 31, the transmission 33, and a motor support 61 inside the housing 25. The motor support 61 is installed in the housing 25 and supports the motor 27. For example, the motor support 61 is provided upright on the inner surface of the housing 25 so as to protrude in the height direction. The pair of motor supports 61 are disposed so as to face each other in the width direction of the first arm 9 perpendicular to the extending direction of the first arm 9 and the height direction of the transfer robot 1. The motor flange 45 is fixed to the upper end portions of the pair of motor supports 61, and the motor supports 61 support the motor 27 via the motor flange 45 so as to sandwich the motor 27 therebetween.

The configurations of the motor 27, the speed reducer 29, the flange 31, the transmission 33, and the like other than the above, and the layout of the respective devices are the same as those in the first embodiment, and thus the description thereof will be omitted.

As shown in FIGS. 11 and 12, a cable support member 49 is provided on the upper portion of the flange 31 at a position different from the input shaft 29a of the speed reducer 29 in the vicinity of the hollow portion 39 (opening 29a portion of the flange 31) of the speed reducer 29. The cable support member 49 (an example of the wire body support) has a support portion 49a and a guide portion 49b. The support portion 49a supports the cable 51 (an example of a line) passing through the hollow portion 39 of the speed reducer 29 at a position between the transmission 33 and the flange 31 in the direction of the first axis Ax1, that is, in the height direction of the transfer robot 1. The guide portion 49b guides the cable 51 held by the support portion 49a so as to be disposed on one side in the widthwise direction of the first arm 9 with respect to the bearing member 37, the pair of motor supports 61, and the like at a height position between the transmission 33 and the flange 31. Accordingly, the cable 51 is wired so as to avoid (detour) the transmission 33, the pair of motor supports 61, the motor 27, and the like in the widthwise direction of the first arm 9. The cable 51 is wired so as to pass through the 29a of the speed reducer 29.

### 3-2. Effects of Second Embodiment

In the second embodiment described above, the speed reducer 29 has the hollow portion 39 penetrating along the first axis Ax1. The speed reducer 29 is disposed such that the output shaft 29b is disposed coaxially with the first axis Ax1 and the input shaft 29a is offset from the first axis Ax1 toward the motor 27 by the length L2. Accordingly, the cable 51 and the like are passed through the hollow portion 39 of the speed reducer 29, and thus the cable 51 and the like can be wired in the first arm 9 through the speed reducer 29, and the input shaft 29a (the bearing member 37) can be prevented from interfering with the cable 51 and the like passed through the hollow portion 39. In this way, the layout of the wiring and the components in the first arm 9 can be optimized, and thus the height dimension of the first arm 9 can be reduced, and the transfer robot 1 can be downsized.

In the present embodiment, a cable support member 49 may be provided to support the cable 51 and the like passing through the hollow portion 39 of the speed reducer 29 at a position between the transmission 33 and the flange 31 in the direction of the first axis Ax1. In this case, the cable 51 and the like wired through the hollow portion 39 can be wired at a height between the transmission 33 and the flange 31 in the first arm 9. This makes it possible to further reduce the height dimension of the first arm 9, and to reduce the size of the transfer robot 1.

In addition, in the present embodiment, the motor support 61 may be extended in the extending direction of the housing 25 and may be a rib that increases the rigidity against deformation in the height direction of the housing 25. In this case, the motor support 61 also functions as a cable guide that prevents interference between the cable and the belt.

In the above description, when there is a description such as “vertical”, “parallel”, or “plane”, the description is not in a strict sense. The terms “perpendicular”, “parallel”, and “plane” mean “substantially perpendicular”, “substantially parallel”, and “substantially plane”, respectively, with design and manufacturing tolerances and errors allowed.

In the above description, when there is a description such as “same”, “similar”, “equal”, or “different” in terms of dimension, size, shape, position, or the like in appearance, the description does not have a strict meaning. The terms “same”, “similar”, “equal”, and “different” allow tolerances and errors in design and manufacturing, and mean “substantially same”, “substantially similar”, “substantially equal”, and “substantially different”.

In addition to the above description, the methods according to the above embodiment and the respective modifications may be appropriately combined and used. In addition, although not illustrated one by one, the above-described embodiment and each modification example are implemented with various modifications added thereto within a range not departing from the gist thereof.

The problems to be solved by the embodiments and the modifications described above and the effects of the embodiments and the modifications are not limited to the above description. Depending on the embodiment, the modification, and the like, a problem not described above can be solved, an effect not described above can be achieved, only a part of the described problems can be solved, and only a part of the described effects can be achieved.

What is claimed is:

1. A transfer robot comprising:
a base;
an arm having a distal end and including a first arm rotatable about a first axis that extends along a height direction of the transfer robot;
a workpiece holder connected to the distal end of the arm and configured to hold a workpiece;
a motor having a motor shaft rotatable around a motor axis and provided inside the first arm such that the motor axis is offset from the first axis by a first predetermined distance;
a speed reducer provided between the base and the first arm such that the first axis passes through the speed reducer and comprising:
an input shaft configured to be rotated around a rotation axis by the motor; and
an output shaft connected to the base and configured to be rotated by the input shaft with a reduced rotation speed;
a transmission provided inside the first arm and configured to transmit rotational power of the motor to the input shaft; and
a motor support provided inside the first arm to support the motor such that the motor is separated from a housing of the first arm.

2. The transfer robot according to claim 1, further comprising:
a connector connecting the speed reducer to the housing,
wherein the motor support has one end and another end opposite to the one end, the one end being connected to the connector, the another end being connected to the motor.

3. The transfer robot according to claim 2,
wherein the connector comprises
a first fixing portion connected to the housing via a plurality of first bolts,
a second fixing portion provided on an inner peripheral side of the first fixing portion and connected to the speed reducer via a plurality of second bolts, and
a third fixing portion connected to the one end of the motor support via a plurality of third bolts.

4. The transfer robot according to claim 2,
wherein a dimension of the transfer robot in the height direction is larger than a dimension of the first arm in a width direction perpendicular to an extending direction of the first arm and perpendicular to the height direction of the transfer robot.

5. The transfer robot according to claim 2,
wherein the motor support includes a first support and a second support that are arranged to face each other in a width direction of the first arm perpendicular to an extending direction of the first arm and a height direction of the transfer robot to sandwich the motor at the another end of the motor support.

6. The transfer robot according to claim 2,
wherein the motor support comprises
a first horizontal portion having the one end and extending in a horizontal direction perpendicular to a height direction of the transfer robot,
a second horizontal portion having the another end and extending in the horizontal direction, and
an inclined portion extending in a direction inclined with respect to the horizontal direction and connecting the first horizontal portion and the second horizontal portion.

7. The transfer robot according to claim 1,
wherein the speed reducer has a hollow that passes through the speed reducer along the first axis.

8. The transfer robot according to claim 7,
wherein the output shaft is provided coaxially with the first axis,
wherein the input shaft is provided such that the rotation axis of the input shaft is offset from the first axis by a second predetermined length, and
wherein the hollow is provided in the output shaft.

9. The transfer robot according to claim 8, further comprising:
a connector connecting the speed reducer to the housing;
a wire body passing through the hollow; and
a wire body support supporting the wire body at a position between the transmission and the connector in a direction of the first axis.

10. The transfer robot according to claim 1,
wherein the transmission comprises
a first pulley connected to the motor,
a second pulley connected to the input shaft, and
a belt wound around the first pulley and the second pulley.

11. A transfer robot comprising:
a base;
an arm having a distal end and including a first arm rotatable about a first axis that extends along a height direction of the transfer robot;
a workpiece holder connected to the distal end of the arm and configured to hold a workpiece;
a motor having a motor shaft rotatable around a motor axis and provided inside the first arm such that the motor axis is offset from the first axis by a first predetermined distance;
a speed reducer provided between the base and the first arm and comprising:
an input shaft configured to be rotated around a rotation axis by the motor and provided such that the rotation axis of the input shaft is offset from the first axis by a second predetermined length;
an output shaft provided coaxially with the first axis and configured to be rotated by the input shaft with a reduced rotation speed; and
a hollow passing through the speed reducer along the first axis; and
a transmission provided inside the first arm and configured to transmit rotational power of the motor to the input shaft.

12. The transfer robot according to claim 11, further comprising:
a connector connecting the speed reducer to a housing of the first arm;
a wire body passing through the hollow; and
a wire body support supporting the wire body at a position between the transmission and the connector in a direction of the first axis.
